(19) United States
(12) Patent Application Publication
(10) Pub. No.: US 2018/0202825 A1
(43) Pub. Date: Jul. 19, 2018

(54) APPARATUS AND METHOD FOR PROVIDING CHARGING EQUIPMENT INFORMATION TO VEHICLE

(71) Applicants: Hyundai Motor Company, Seoul (KR); Kia Motors Corporation, Seoul (KR)

(72) Inventors: Jae Seok You, Seoul (KR); Chae Mo Yang, Gunpo (KR); Kyu Beom Ko, Incheon (KR); Deok Keun Shin, Yongin (KR)

(21) Appl. No.: 15/824,033

(22) Filed: Nov. 28, 2017

(30) Foreign Application Priority Data
Jan. 16, 2017 (KR) 10-2017-0007149

(51) Int. Cl. G01C 21/34; B60L 11/18; G07C 5/00; G08G 1/00

(52) U.S. Cl. CPC G01C 21/3469; B60L 11/1824; B60L 11/1861; G07C 5/008; B60L 2240/72; B60L 2230/16; B60L 2260/52; B60L 2240/80; B60L 2240/62; G08G 1/20

(57) ABSTRACT

A method for providing charging station information to a vehicle includes collecting a battery charging state, a driving distance and a charging history from a plurality of vehicles, calculating a latent utilization rate regarding at least one charging station based on at least one of the battery charging state, the driving distance and the charging history information, and determining a charging availability information regarding the at least one charging station based on the latent utilization rate to provide the charging availability information to at least one vehicle included in the plurality of vehicles.

### CROSS-REFERENCE TO RELATED APPLICATION

This application claims under 35 U.S.C. § 119(a) the benefit of Korean Patent Application No. 10-2017-0007149, filed on Jan. 16, 2017 in the Korean Intellectual Property Office, the entire contents of which are incorporated by reference herein.

### BACKGROUND

### (a) Technical Field

The disclosure relates to an apparatus and method for providing charging equipment information to a vehicle, and more particularly, to an apparatus and method for estimating an availability of a charging station where an electric vehicle is charged and providing the availability to the vehicle to reduce wasted time for charging.

### (b) Description of the Related Art

It is a goal to increase the number of facilities configured for charging a battery mounted in an electric vehicle so that a user or driver can easily and quickly charge the battery of the electric vehicle, similar to putting a gas in a vehicle. Intangible or tangible facilities, equipment and software, provided in the process of supplying electric power to an electric vehicle, may be collectively referred to as charging infrastructure. The charging infrastructure may include electric power supply facilities, electric power distribution facilities, charging facilities, communication facilities, supplementary installation, and the like. Compared with vehicles using fossil fuels, electric vehicles may have difficulty in proliferating because of a short driving distance on a single charge, a lack of charging infrastructure, a long charging time, a high cost of battery, or the like.

Through wireless communication technology, a vehicle now can receive necessary information regarding not only its maintenance but also driving or traveling. For example, the vehicle can be provided via wireless communication technology with information about a gas station that can refuel a gas or a charging station that can deliver electric energy. In particular, the information regarding the charging station provided into an electric vehicle may include location and operating state (e.g., charging, available, suspend, overhaul, etc.) of the charging station. In addition, the electric vehicle may be provided with an expected waiting time for use of a particular charging station and the like.

### SUMMARY

According to the present disclosure, it is possible to take into account charging potential of running vehicles within a predetermined range from a subject vehicle to estimate an availability of a specific charging station and provide an apparatus and a method for transmitting more accurate information about the specific charging station information to a user or a driver.

In addition, the disclosure can collect information about charging station from a plurality of vehicles, and provide a method and an apparatus for independently estimating availability of the charging station without sharing information with another institution, a business entity or operator, and the like, which operates the charging station.

A method for providing charging station information to a vehicle can include: collecting a battery charging state, a driving distance and a charging history from a plurality of vehicles; calculating a latent utilization rate regarding at least one charging station based on at least one of the battery charging state, the driving distance and the charging history; and determining charging availability information regarding the at least one charging station based on the latent utilization rate to provide the charging availability information to at least one vehicle included in the plurality of vehicles.

The latent utilization information (unit: %) can be obtained by: either dividing the number of charging vehicles by the number of available chargers or dividing an average of charging times by the hour from the charging history by the number of available chargers; and multiplying divided value by 100.

The charging availability information based on the latent utilization rate can be classified into one of congested, good and marginal, and be displayed through at least one of different colors, shapes and phrases, and wherein each color, each shape or each phrase corresponds to one of the congested, the good and the marginal.

When the latent utilization rate is less than 200%, the charging availability information can be determined as the marginal. When the latent utilization rate is 200% or more and less than 400%, the charging availability information can be determined as the good. When the latent utilization information is equal to or greater than 400%, the charging availability information can be determined as the congested.

The calculating the latent utilization rate can include: recognizing locations of the vehicles and classifying the plurality of vehicles based on whether each vehicle is located within a predetermined region; determining the number of charging vehicles, each of which requires charging based on at least one of the battery charging state and the driving distance delivered from each vehicle located in the predetermined region; determining the number of available chargers in the at least one charging station located in the predetermined region; and calculating the latent utilization rate based on the number of the charging vehicles and the number of the available chargers.

The calculating the latent utilization rate can include: classifying the charging history collected from the plurality of vehicles based on a predetermined region and a predetermined time; determining the number of charging times in response to the predetermined region and the predetermined time; determining the number of available chargers in the at least one charging station located in the predetermined region; and calculating the latent utilization rate based on the number of charging times and the number of available chargers.

The calculating the latent utilization rate can include: determining the number of target vehicles which are moving within a predetermined distance from location of the at least one charging station and whose battery charging state is less than a predetermined level or driving distance is less than or equal to a threshold value; and calculating the latent utilization rate based on the number of target vehicles and the number of chargers included in the at least one charging station.

The predetermined distance can be 0.5 to 1.0 times the threshold value or 0.5 to 1.0 times the maximum driving distance according to the predetermined level.

The calculating the latent utilization rate can include: classifying the charging history collected from the plurality of vehicles based on location of the at least one charging station and a predetermined time; determining the number of charging times according to the location of the at least one charging station and the predetermined time; and calculating the latent utilization rate based on the number of charging times and the number of available chargers.

The method can further include analyzing the charging history to recognize the number of chargers included in the at least one charging station as well as whether each of the chargers is failed.

An apparatus for providing a charging station information to a vehicle can include: an information collecting unit configured to collect and store a battery charging state, a driving distance and a charging history from a plurality of vehicles through a wireless network; a calculation unit configured to calculate a latent utilization rate regarding at least one charging station based on at least one of the battery charging state, the driving distance and the charging history; and an information providing unit configured to provide the latent utilization rate to at least one vehicle included in the plurality of vehicles.

The apparatus can further include a determination unit configured to analyze the charging history to determine the number of chargers included in the at least one charging station as well as whether each of the chargers is failed, wherein the information providing unit provides the latent utilization rate as well as the number of chargers and whether each of the chargers is failed.

The latent utilization information (unit: %) can be obtained by: either dividing the number of charging vehicles by the number of available chargers or dividing an average of charging times by the hour from the charging history by the number of available chargers; and multiplying divided value by 100.

The calculation unit can be configured to: recognize locations of the vehicles and classifying the plurality of vehicles based on whether each vehicle is located within a predetermined region; determine the number of charging vehicles, each of which requires charging based on at least one of the battery charging state and the driving distance delivered from each vehicle located in the predetermined region; determine the number of available chargers in the at least one charging station located in the predetermined region; and calculate the latent utilization rate based on the number of the charging vehicles and the number of the available chargers.

The calculating unit can be configured to: classify the charging history collected from the plurality of vehicles based on a predetermined region and a predetermined time; determine the number of charging times in response to the predetermined region and the predetermined time; determine the number of available chargers in the at least one charging station located in the predetermined region; and calculate the latent utilization rate based on the number of charging times and the number of available chargers.

The calculating unit can be configured to: determine the number of target vehicles which are moving within a predetermined distance from location of the at least one charging station and whose battery charging state is less than a predetermined level or driving distance is less than or equal to a threshold value; and calculate the latent utilization rate based on the number of target vehicles and the number of chargers included in the at least one charging station.

The calculating unit can be configured to: classify the charging history collected from the plurality of vehicles based on location of the at least one charging station and a predetermined time; determine the number of charging times according to the location of the at least one charging station and the predetermined time; and calculate the latent utilization rate based on the number of charging times and the number of available chargers.

An in-vehicle apparatus for showing charging station information can include an information transmission unit configured to transmit a battery charging state, a driving distance and a charging history through the wireless network; a determination unit configured to determine charging availability information regarding the at least one charging station based on at least one of a latent utilization rate and the number of charging times delivered through the wireless network; and a display unit configured to display the charging availability information in a predetermined form.

The charging availability information based on the latent utilization rate can be classified into one of congested, good and marginal, and be displayed through at least one of different colors, shapes and phrases, and wherein each color, each shape or each phrase corresponds to one of the congested, the good and the marginal.

Advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 shows an example of displaying charging station information;

FIG. 2 describes a system configured to collect and display charging station information from a plurality of vehicles;

FIG. 3 shows a method of providing charging station information to a vehicle;

FIG. 4 describes a first example of a method for calculating a latent utilization rate;

FIG. 5 shows a first example of a method for displaying charging station information;

FIG. 6 illustrates a specific example of the method for calculating the latent utilization rate shown in FIG. 4;

FIG. 7 shows a second example of the method for calculating the latent utilization rate;

FIG. 8 illustrates a specific example of the method for calculating the latent utilization rate shown in FIG. 7;

FIG. 9 shows a third example of the method for calculating the latent utilization rate;

FIG. 10 describes a second example of the method for displaying the charging station information;

FIG. 11 illustrates a specific example of the method for displaying the charging station information shown in FIG. 10;

FIG. 12 shows a fourth example of the method for calculating the latent utilization rate;

FIG. 13 illustrates a specific example of the method for calculating the latent utilization rate shown in FIG. 12; and

FIG. 14 shows an apparatus configured to provide the charging station information to a vehicle and an in-vehicle apparatus configured to show the charging station information.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

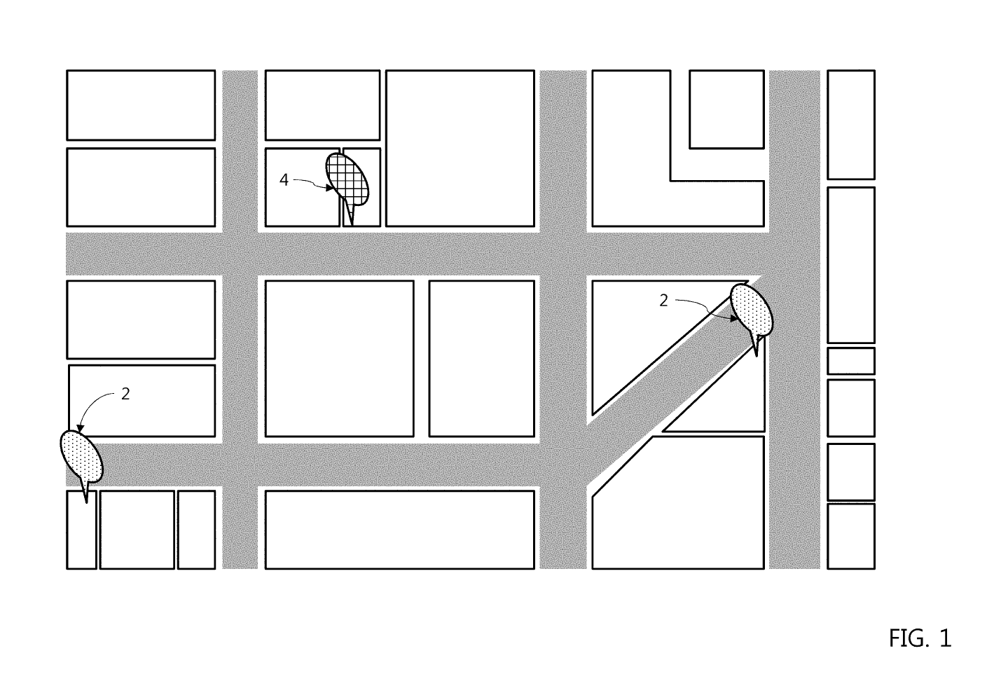

FIG. 1 shows an example of displaying charging station information.

As shown, a vehicle may be equipped or engaged with an apparatus (e.g., GPS, navigation or etc.) which is capable of displaying map information. The map information provided to a user or a driver may include information regarding a gas station or a charging station for enhancing or extending a mobility and/or range of the vehicle. By way of example but not limitation, in the case of an electric vehicle using electric energy stored in a battery to travel, it is possible that the apparatus shows road information as well as a location of the charging station. Further, the apparatus may use different marks 2, 4 to report the failure of a charging station or a charger. For example, the different marks 2, 4 can be shown with map information based on collected information about location of a charging station or charger (e.g., GPS information, etc.) and whether each of the charging station or the charger is faulty or defective.

Techniques providing charging station information to a vehicle can use data delivered from a charging station such as a charging status of the charging station or a time required for charging at the charging station. However, it is difficult to accurately provide the charging station information when an operator or a business entity operating the charging station, a manufacturer of the vehicle and an operator operating the telematics server for vehicle maintenance are different and/or they might not share related information with each other. Further, even if information regarding the charging station is shared and provided with each other, it might be difficult to predict a charging load factor when there is no estimation about latent or potential charging-related vehicles which could be charged or are likely to be charged. By way of example but not limitation, even if a function of reserving a specific charging station is provided, the charging load factor of that charging station can just consider other users or vehicles having a reservation of the charging station. Thus, a user or a vehicle having no reservation of the charging station may not be considered to determine the charging load factor. Accordingly, even if a user or a driver, who has been informed that a charging station is available, visits the charging station, the user or the driver could not charge his or her vehicle immediately. Although a quick charging might be is available on a specific charging station, it could take more than 30 minutes to quickly and fully charge a particular vehicle. This can dramatically reduce the mobility and/or range of the electric vehicle. If the user or the driver must wait for 30 minutes for starting to charge his or her vehicle at a charging station, it can be a serious inconvenience.

Embodiments of the disclosure can be related to an apparatus and method for considering other charging-related vehicles operating around a subject vehicle within a predetermined range and providing a latent utilization rate (or charging load factor) regarding a charge station or a charger to the subject vehicle, through a network server which collects plural various data from each electric vehicle via a wireless communication technology to support a vehicle maintenance.

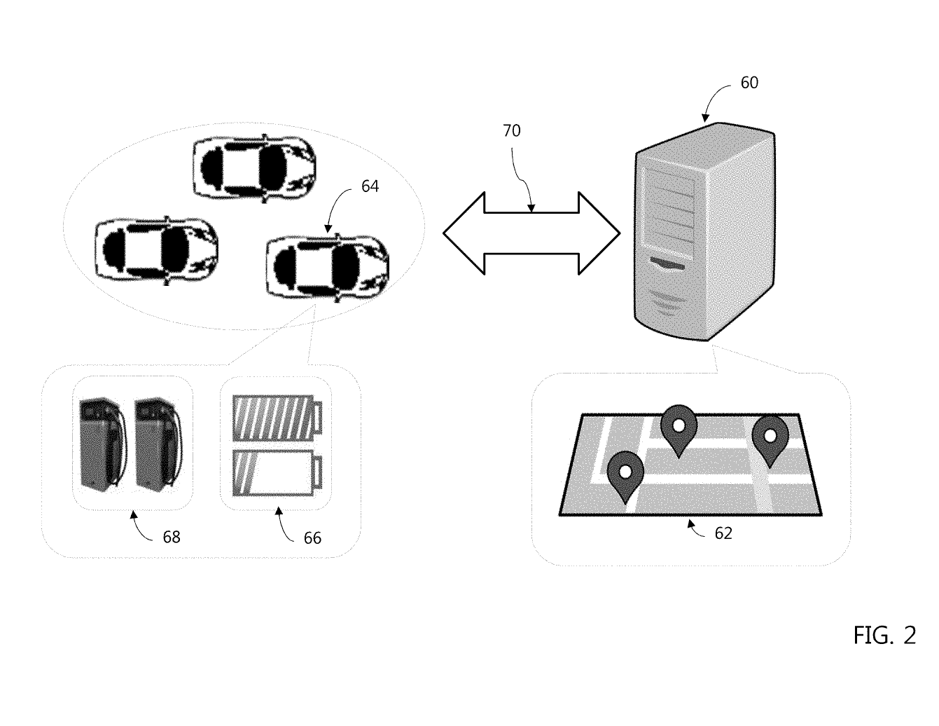

FIG. 2 describes a system configured to collect and display charging station information from a plurality of vehicles.

As shown, a system can be capable of collecting charging station information from a plurality of vehicles, estimating and calculating a latent utilization rate of a charging station, and providing the latent utilization rate to at least one vehicle included in the plurality of vehicles. The system may be implemented by at least one of a network server 60, a vehicle 64 and the combination thereof. A plurality of vehicles 64 can transmit their own information about charging to the network server 60. The network server 60 can process or handle data or information delivered from the plurality of vehicles 64 to estimate or calculate a latent utilization rate regarding at least one charging station and can provide the latent utilization rate to at least one vehicle included in the plurality of vehicles 64.

The information that the plurality of vehicles 64 can transmit to the network server 60 may include a battery charging state 66 (of batteries mounted on the vehicle), a charge history 68, and the like. Further, the plurality of vehicles 64 can transmit a distance to empty (DTE), estimated or calculated based on a current driving state, a battery charging state, and the like of the vehicle, to the network server 60.

The network server 60, which can be connected to the plurality of vehicles 64 through a wireless network communication network 70, may include map information, locations 62 of charging stations and chargers. The network server 60 can estimate and calculate the latent utilization rate of the charging station or the charger based on the information transmitted from the plurality of vehicles 64.

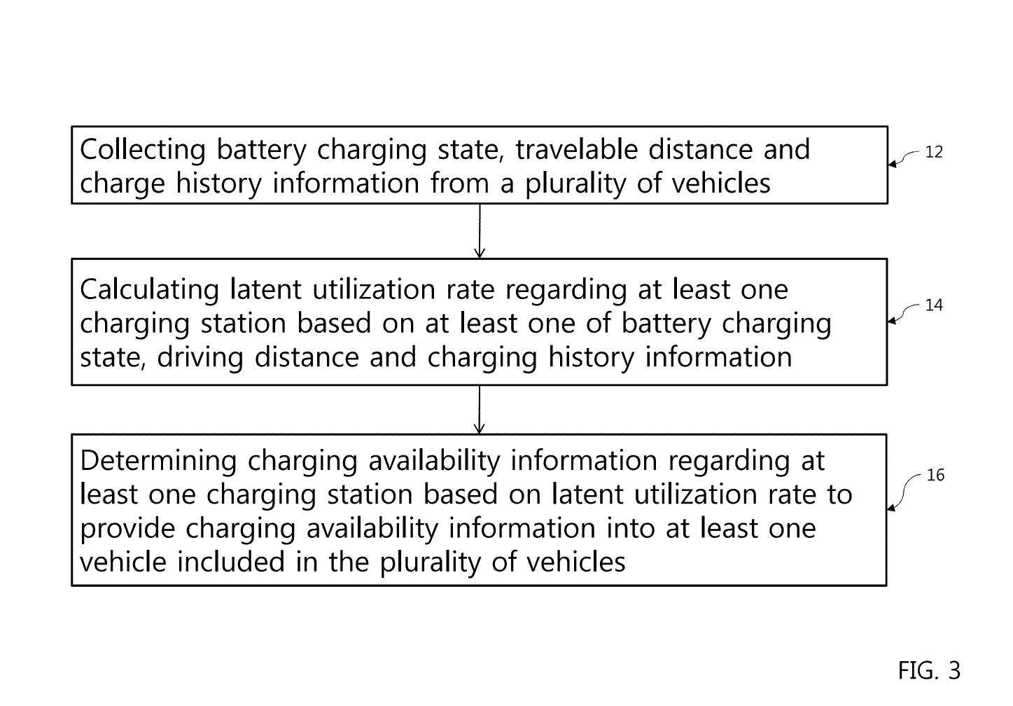

FIG. 3 shows a method of providing charging station information to a vehicle.

As shown, a method of providing charging station information to a vehicle can include collecting a battery charging state, a travelable distance, and charge history information from a plurality of vehicles (step 12), calculating a latent utilization rate regarding at least one charging station based on at least one of the battery charging state, the driving distance and the charging history information (step 14), and determining charging availability information regarding the at least one charging station based on the latent utilization rate to provide the charging availability information to at least one vehicle included in the plurality of vehicles (step 16).

Drivers or users of the plurality of vehicles 64 (as shown in FIG. 2) can recognize information about charging stations through a display device (e.g., a head unit or a multimedia system, etc.) equipped in the vehicle. By way of example but not limitation, charging availability information based on latent utilization is classified into one of congested, good and marginal. The charging availability information can be displayed through a mark having at least one of different colors, shapes and phrases, each corresponding to congested, good and marginal.

When the latent utilization is delivered from the network server 60 (see FIG. 2), the vehicle determines the charging availability information based at least on the latent utilization rate. By way of example but not limitation, if the latent utilization rate is less than 200%, the charging availability information may be determined as marginal. Also, when the latent utilization rate is 200% or less than 400%, the charging availability information can be determined to be good. Further, when the latent utilization rate is 400% or more, the charging availability information can be determined as congested. Herein, a range of the latent utilization rate to determine the charging availability information may vary, according to an embodiment. The range of the latent utilization rate can also be changed by a manufacturer of the vehicle, an organization or a group (e.g., service provider) for maintenance, maintenance and management of the vehicle, or drivers or users of the vehicle. When the range of the latent utilization rate which is used for determining the charging availability information is set lower, the number of the chargers or the charging stations where the charging availability information is available may be reduced, while it may be unlikely that a driver or a user of a vehicle waits for the charging at a charging station or a delay in charging operation may be increased. On the contrary, if the range of the latent utilization rate for determining the charging availability information increases, the number of chargers or charging stations in which the charging availability information is displayed as marginal is increased, but the possibility of delay may be increased when a driver or a user of a vehicle arrives at the charging station or reaches the charger.

The method for providing the charging station information to the vehicle may further include analyzing the charging history to recognize the number of chargers included in the at least one charging station as well as whether each of the chargers is failed. The network server 60 can receive or collect charge history from a plurality of vehicles 64. The charging history may include information of time (timings of start, end, etc.) which is required for the vehicle to be charged, information of whether charging the vehicle at a specific charger is successfully completed, information of charging station location, and the like. The network server 60 may collect information about specific chargers and specific charging stations transmitted from the plurality of vehicles 64 to determine whether the specific charger or the specific charging station operates normally or has broken down, and the like. In this way, it is possible to update the information regarding the charger and the charging station by analyzing information which is transmitted from the plurality of vehicles 64 without further information to be delivered from an organization or an entity that operates a charging station, a charger, or the like.

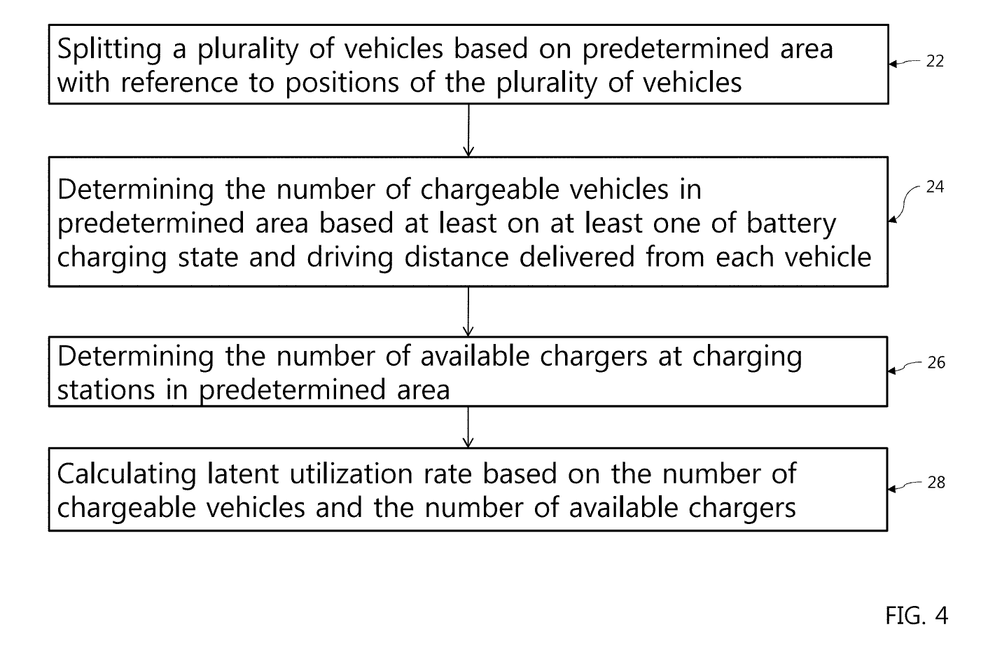

FIG. 4 describes a first example of a method for calculating a latent utilization rate.

As shown, the method of calculating the latent utilization rate can include splitting a plurality of vehicles based on a predetermined area with reference to positions of the plurality of vehicles (step 22), determining the number of chargeable vehicles in the predetermined area based at least on at least one of a battery charging state and a driving distance delivered from each vehicle (step 24), determining the number of available chargers at charging stations in the predetermined area (step 26), and calculating a latent utilization rate based on the number of chargeable vehicles and the number of available chargers (step 28). This latent utilization rate based on the predetermined area may assist a driver or a user driving a vehicle to determine which area it would be advantageous for the driver or the user to charge his or her vehicle. By way of example but not limitation, when it is necessary to charge a vehicle moving from a region A to a region H while it is in transit, it is possible to determine, based on the latent utilization rate, which region B, C, D, E or F between the region A and the region H the vehicle could be charged faster, i.e., which region a charging time (for example, charge waiting time) could be more reduced.

Here, the latent utilization rate (unit: %) may be a value obtained by dividing the number of vehicles to be charged (i.e., chargeable or charging-probable vehicles) by the number of available chargers and then multiplying a divided value by 100. The formula can be expressed as follows.

$$\frac{The number of charging \text{-} probable vehicles}{The number of chargers} \times 100$$

Herein, the number of charging-probable vehicles may include the number of vehicles which are required to be charged in a predetermined area based on the battery charging state or the driving distance transmitted from each vehicle located or moving in the predetermined area. By way of example but not limitation, the number of charging-probable vehicles can be determined based on the number of first cars whose battery charging state is less than 10% in an area B, the number of second cars whose driving distance is 10 or 20 km or less in the area B, or the sum of them (first cars and second cars). Herein, in an embodiment, a threshold value or a critical range used as a criterion for determining whether charging is necessary based on the battery charging state or the driving distance may be changed.

In addition, the number of charging stations (chargers) in a specific area can be determined based on the number of chargers (except for the failed chargers) that can charge the vehicle in the specific area (for example, area B), which can be recognized based on charging history transmitted from a plurality of vehicles, each having an experience in being charged in the specific area. In this way, the latent utilization rate can be calculated based on the number of chargeable vehicles and the number of available charging stations (chargers) in the specific area.

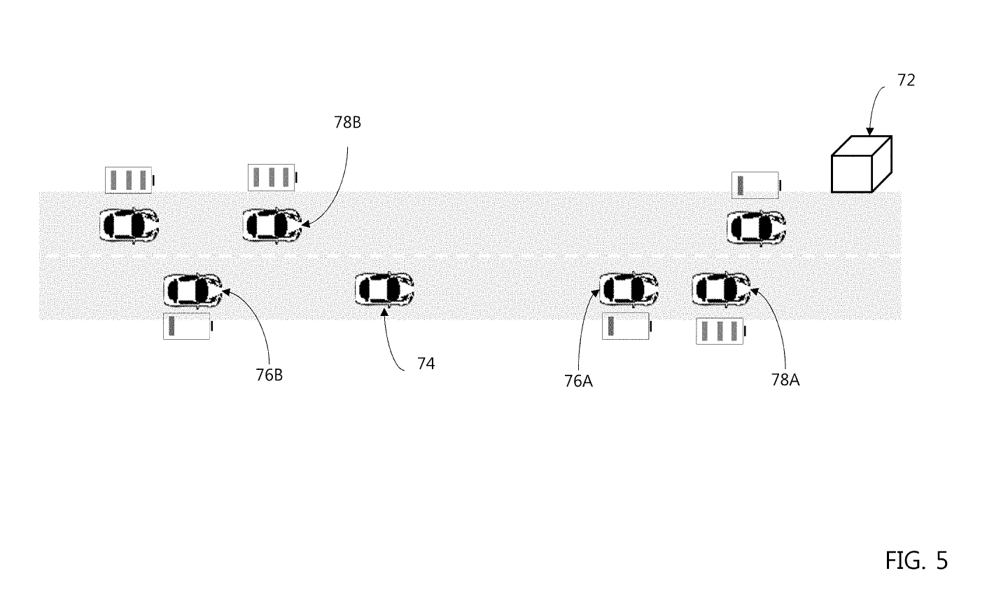

FIG. 5 shows a first example of a method for displaying charging station information.

As shown, the map information 86 provided to a driver or a user driving a vehicle may include a plurality of predetermined regions. According to the embodiment, the region may be divided into administrative districts, or virtual areas set to a predetermined range.

Through the method of calculating the latent utilization rates described in FIG. 4, a latent utilization rate of charging station can be determined in each of regions 82A, 82B and 82C. In each region, a position of a charging station 84 can be displayed more accurately. When different latent utilization rates are calculated for the respective regions 82A, 82B and 82C, advance information about availability of each region area (i.e., charging availability information based on a latent utilization rate), which has different colors or patterns, each standing for congested, good or marginal, can be delivered to the user or driver of the vehicle.

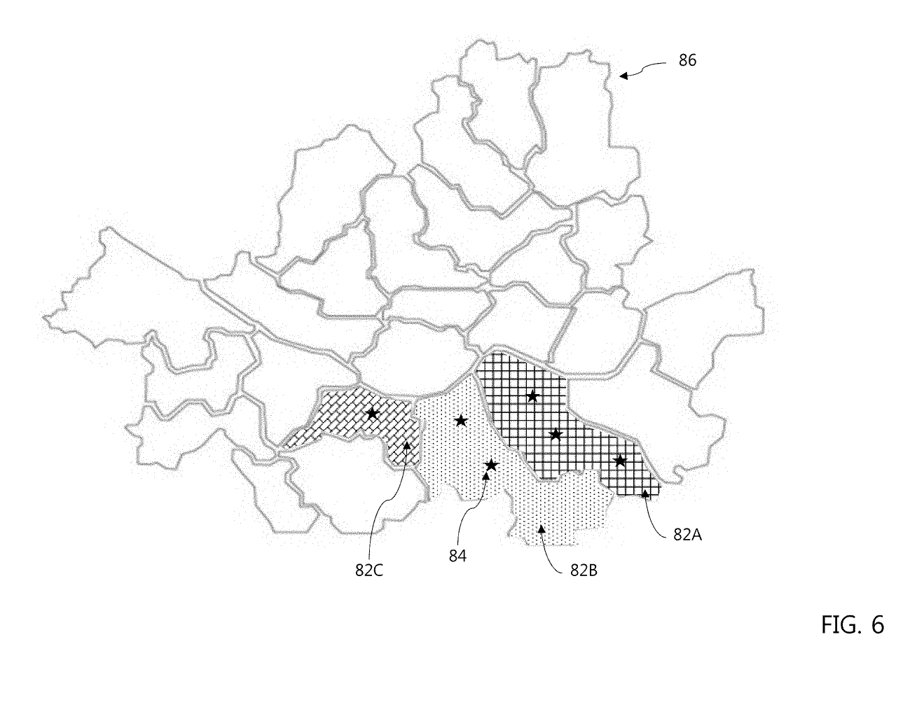

FIG. 6 illustrates a specific example of the method for calculating the latent utilization rate shown in FIG. 4.

As shown, in a place such as a highway, it is possible to provide a more accurate latent utilization rate in response to a specific vehicle. By way of example but not limitation, the latent utilization rate at a charging station (or charger) 72 located on the road can be provided to a target vehicle 74 that requests information about the charging station. The network server can receive a battery charging status from each of a plurality of vehicles (74, 76A, 76B, 78A, 78B) running on the road. The network server can calculate the latent utilization rate of the charging station 72 based on the battery charging state of each vehicle. It can be determined that the vehicle 76A having a low battery charging state is considered a chargeable vehicle and that the vehicle 78A having a high battery charging state is not considered a chargeable vehicle.

On the other hand, the vehicles 76B and 78B farther from the charging station 72 than the target vehicle 74 receiving the information about the charging station may not be considered in determining or calculating the information about the charging station, which is provided to the target vehicle 74. This is because it might be difficult for the vehicles 76B and 78B to have a decisive effect on a charging plan or charging operation of the target vehicle 74 at the charging station 72. Therefore, for determining the number of chargeable vehicles, the vehicle 76B that is farther from the charging station 72 than the target vehicle 74 may not be considered even if its battery charging state is lower than a threshold level.

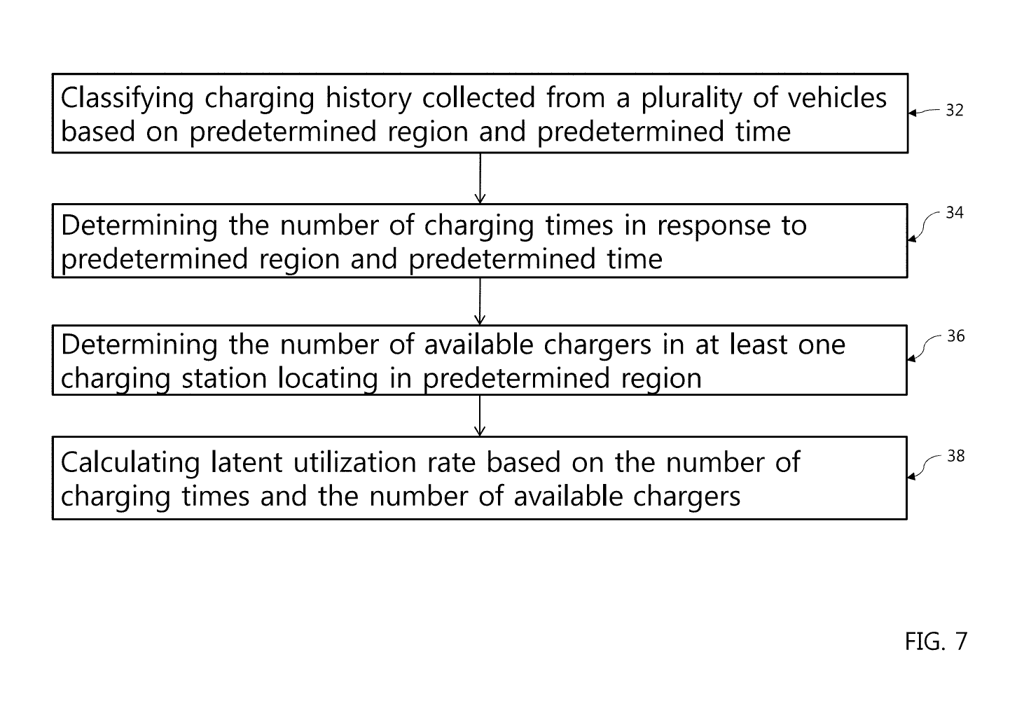

FIG. 7 shows a second example of the method for calculating the latent utilization rate.

As shown, the method of calculating the latent utilization rate can include classifying the charging history collected from a plurality of vehicles based on a predetermined region and a predetermined time (step 32), determining the number of charging times in response to the predetermined region and the predetermined time (step 34), determining the number of available chargers in at least one charging station located in the predetermined region (step 36), and calculating the latent utilization rate based on the number of charging times and the number of available chargers (step 38).

By way of example but not limitation, the number of charging times may be calculated by dividing the total number of charging times in the last month by the day of week, and then calculating an average by a day and an hour. The latent utilization rate can be a value obtained by dividing the average of the day and the time by the number of available chargers, then multiplying the divided value by 100. The formula is expressed as follows.

$$\frac{The number of charging times ( by the hour )}{The number of chargers ( regional basis )} \times 100$$

Herein, the average number of charging times by a region and a time is a kind of statistical calculated value about the number of vehicles charged through a specific charging station (or charger) located in a predetermined area. By way of example but not limitation, the number of vehicles charged from 1 pm to 2 pm on Monday in the last month at each of multiple charging stations in a specific area B can be averaged. Further, if 30 vehicles were charged in the specific area B on the first and second Mondays in the last month (from 1:00 pm to 2:00 pm), and 10 vehicles were charged at that time on the third and fourth Mondays in the last month, On Monday in the last month, the average number of vehicles charged at the charging stations in the specific area B at that time becomes 20.

In addition, the number of charging stations (chargers) in a specific area can be determined based on the number of chargers (except for the failed chargers) that can charge the vehicle in the specific area (for example, area B), which can be recognized based on charging history transmitted from a plurality of vehicles, each having an experience in being charged in the specific area. In this way, the latent utilization rate can be calculated based on the number of chargeable vehicles and the number of available charging stations (chargers) in the specific area.

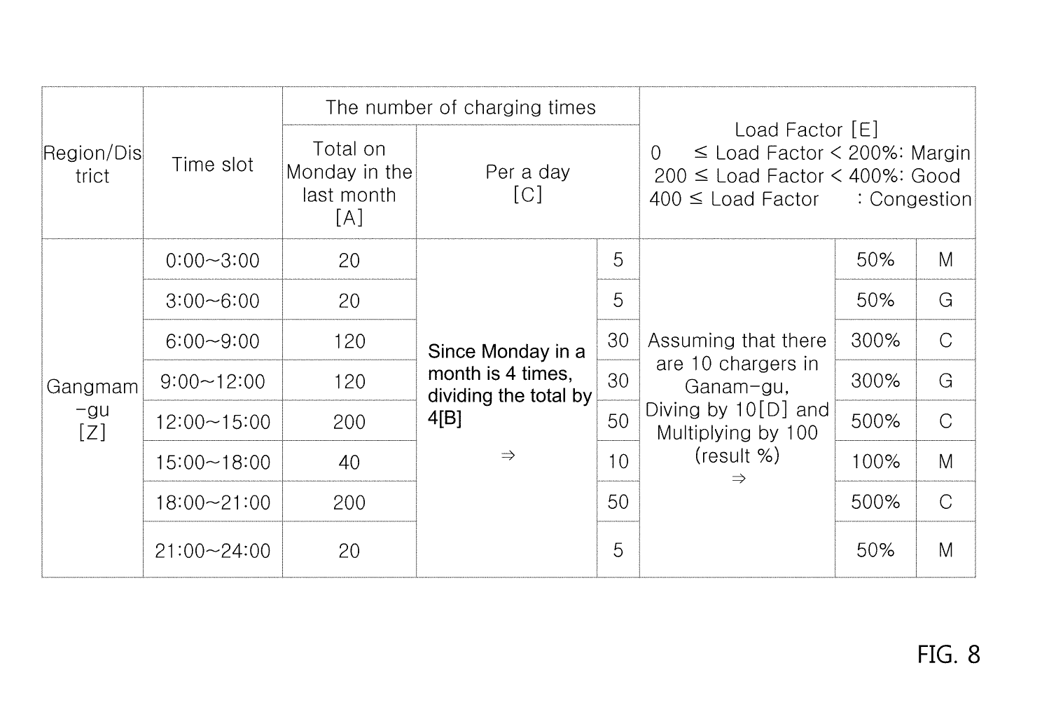

FIG. 8 illustrates a specific example of the method for calculating the latent utilization rate shown in FIG. 7.

As shown, the number of times the vehicle is charged in a specific region (Z) (e.g., Gangnam-gu) on a specific day of the week (e.g., Monday) during the past one month can be summed (A). Further, the day can be divided by the time zone, and the number of times the vehicle is charged in the specific region (Z) can be summed Assuming that a certain day of the week is four times (B) for one month, the average value (C) of the number of charging times by time of day on a specific day can be calculated. The load factor (E) can be calculated by dividing the average value C of the charging times by the number of charging devices (chargers) (e.g., 10 generations (D)) included in the specific region (Z). When the load factor E is less than 200%, the charging availability information can be determined as a marginal, and when the load factor E is less than 400% from 200%, the charging availability information can be determined as a good. Further, when the load factor E is 400% or more, the charging availability information can be determined as congested. The charging available information according to the determined latent utilization rate (i.e., load factor) can provide the information about each of the time zone when the vehicle is moving in the specific region (Z) or the vehicle passing through the specific region (Z) requests the charging station information.

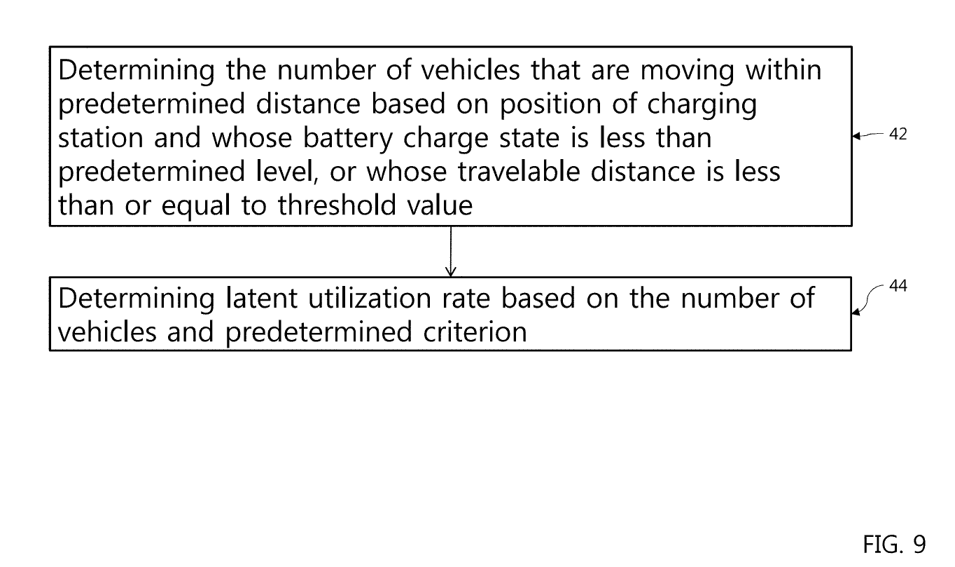

FIG. 9 shows a third example of the method for calculating the latent utilization rate.

As shown in the figure, the method of calculating the latent utilization rate can include determining the number of vehicles that are moving within a predetermined distance based on the position of the charging station and whose battery charge state is less than a predetermined level, or whose travelable distance is less than or equal to a threshold value (step 42), and determining the latent utilization rate based on the number of vehicles and a predetermined criterion (step 44). By way of example but not limitation, the predetermined distance may be 0.5 to 1.0 times the threshold value, or 0.5 to 1.0 times the maximum movable distance depending on the predetermined level. In addition, the preset reference may correspond to the number of rechargeable chargers included in the charging station.

If the latent utilization rate described in FIG. 4 is calculated based on a specific area/region, the latent utilization rate described in FIG. 9 can be determined based on a specific charging station rather than the specific area/region. By way of example but not limitation, in order to calculate the latent utilization rate based on a P charging station, the number of vehicles that are determined to be charged among moving or stopping vehicles within a predetermined range (e.g., 10 km, 20 km, etc.) from the P charging station could be calculated, and the latent utilization rate can be determined based on the number of vehicles and the number of chargers equipped in the P charging station. Herein, which vehicle is required to be charged may be determined based at least on a battery charge state or a driving distance transmitted from the vehicle.

On a basis of each charging station, the latent utilization rate can be determined based on the number of charging-required vehicles with a predetermined range and the number of charging devices that can be available to charge a vehicle in the charging station. The formula is expressed as follows.

$$\frac{The number of charging \text{-} required vehicles}{The number of chargers} \times 100$$

On the other hand, if the number of vehicles requiring charging is larger than a predetermined number, it can be displayed as charging prediction information such as congested, good, and marginal. For example, congested can be indicated when four or more vehicles are required to be charged, good when two to three vehicles are required, and marginal when less than one vehicle is required. At this time, the determination of the charging availability information may be different according to the number of chargeable chargers included in the charging station.

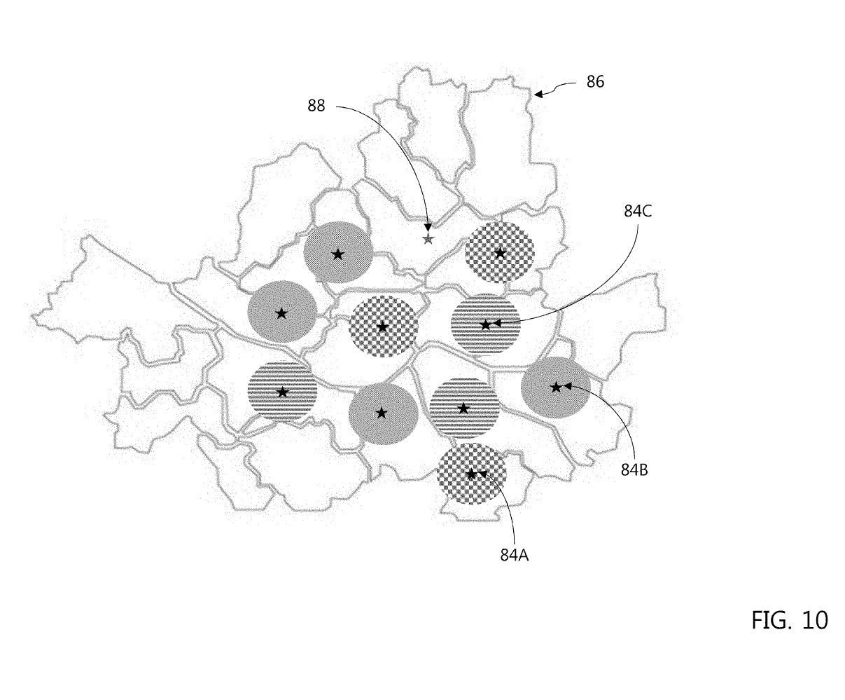

FIG. 10 describes a second example of the method for displaying the charging station information.

As shown, map information 86 provided to a driver or a user of the vehicle may include location information about a plurality of charging stations or chargers 84A, 84B, 84C that may be matched with the map information. Further, in a case where the charging station or the charger is not able to charge any vehicle due to failure, maintenance or the like, it can be displayed through a separate color or pattern 88.

The latent utilization rate can be estimated for each charging station or charger 84A, 84B, 84C, and the charging available information is displayed for each of the charging stations 84A, 84B, 84C through a mark having different colors or patterns determined according to the charging available information, so that the driver or the user of the vehicle can visually recognize information of the charging station or the charger.

According to the method of calculating the latent utilization rate described in FIG. 9, the latent utilization rate of the charging station can be determined for each charging station 84A, 84B, 84C. When different latent utilization rates calculated for each charging station 84A, 84B, 84C, advance information about the charging stations (i.e., charging available information based on latent utilization rates) can be provided through a mark or a symbol having different colors or patterns such as congested, good and marginal to the user or driver of the vehicle.

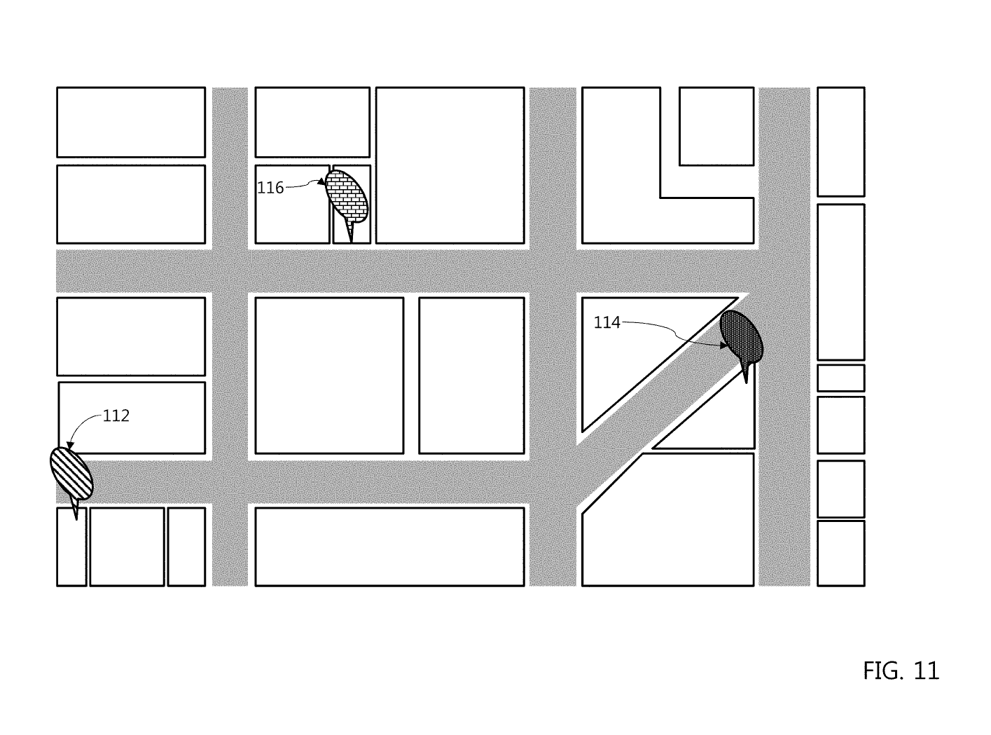

FIG. 11 illustrates a specific example of the method for displaying the charging station information shown in FIG. 10.

As shown, plural marks or symbols 112, 112, 113 can be displayed through a navigation device of the vehicle with colors, patterns, and the like, which stand for charging availability information, such as congested, good and marginal, for each charging station at corresponding locations of charging stations included in road information, to be provided to the user or the driver of the vehicle.

Unlike a case where charging station information is provided by a method similar to that described in FIG. 1, there is a difference. Plural marks or symbols shown in FIG. 11 (even though similar to that in FIG. 1) might be not used for simply notifying the failure of the charging station but for providing the charging prediction information based at least on the latent utilization rate of each charging station, rather than. In particular, charging availability information based on a latent utilization rate can be considered more precise information so that a user or a driver of vehicle can reduce the amount of time to wait for recharging his or her vehicle when visiting a charging station selected based on the charging availability information.

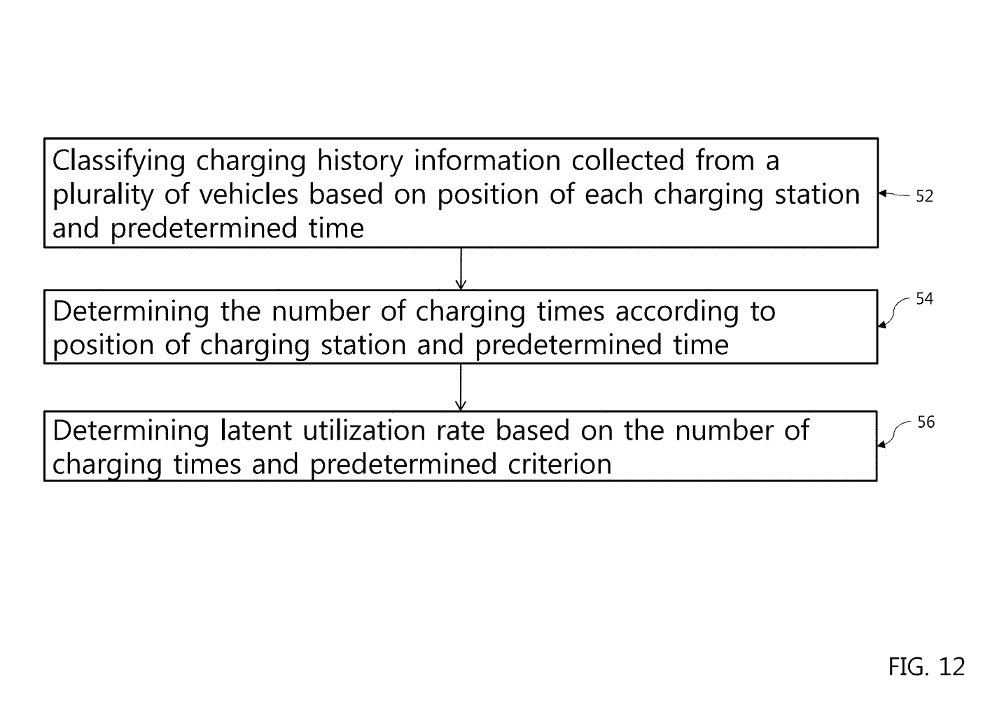

FIG. 12 shows a fourth example of the method for calculating the latent utilization rate.

As shown, the method for calculating the latent utilization rate can include classifying charging history information collected from a plurality of vehicles based on a position of each charging station and a predetermined time (step 52), determining the number of charging times according to the position of the charging station and the predetermined time (step 54), and determining a latent utilization rate based on the number of charging times and a predetermined criterion (step 56). By way of example but not limitation, the number of charging times may be determined by dividing the total number of charging times by a day of the week in the past month based on the charging station, calculating the average for each day of the week or each time (e.g., hours). The latent utilization rate is obtained by dividing the (day or hours) average by the number of available chargers and multiplying divided value by 100. The formula is expressed as follows.

$$\frac{The number of charging times ( by the hour )}{The number of chargers at a specific charging station} \times 100$$

Herein, the average of charging times according to a time is a statistical calculation of the number of vehicles charged in a predetermined charging station (or through a charger). By way of example but not limitation, the average for the number of vehicles charged from 1 pm to 2 pm on every Monday during the past 1 month at P charging station could be calculated. For instance, if three cars were charged at the P charging station (at 1:00 pm to 2:00 pm) on the first and second Monday of the month, and one car was charged at that time on the third and fourth Monday at the P charging station, the average for number of vehicles using the P charging station at that time on Monday becomes two.

In addition, the number of charging stations (chargers) can be recognized from charging histories delivered from plural vehicles. Particularly, the number of available chargers (except those that have failed) that can charge the vehicle to the charging station can be correctly determined based on the charging histories transmitted from a plurality of vehicles (using a big data approach). In this way, the latent utilization rate can be calculated based on the number of vehicles required to be charging and the number of available charging stations (chargers).

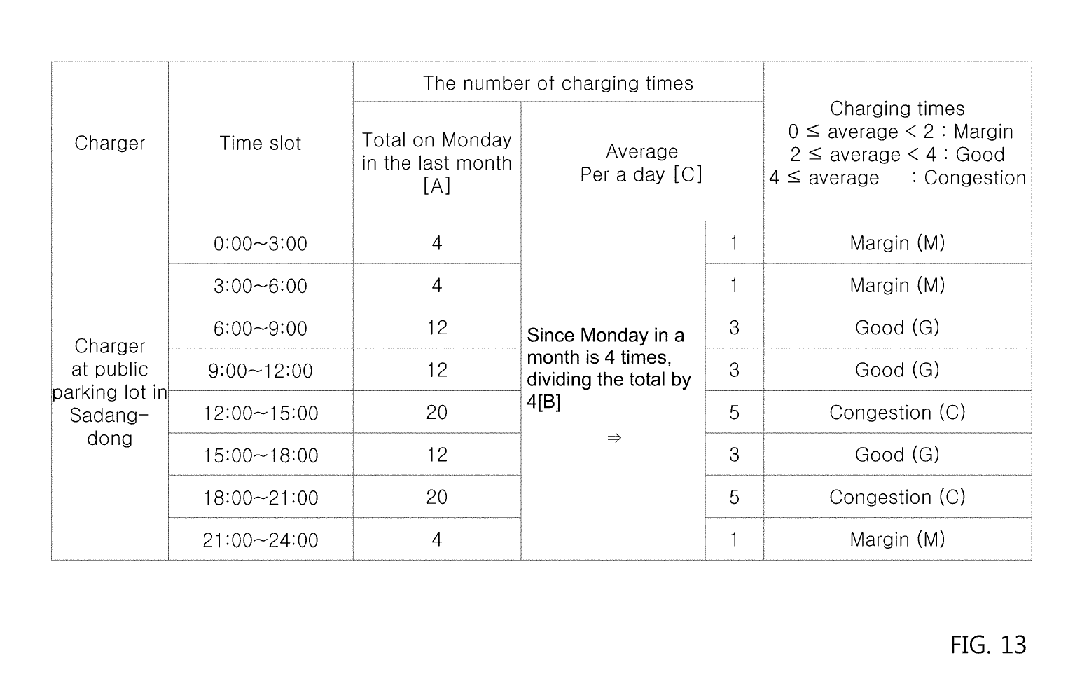

FIG. 13 illustrates a specific example of the method for calculating the latent utilization rate shown in FIG. 12.

As shown, at a specific charger Q, a specific day (for example, Monday) during the past one month can be summed by dividing the day by time/hours (time range), and the number of times the vehicle is charged on the specific day can be summed Assuming that Monday is four times [B] for one month, the average value [C] of the number of charging times by every three hours on Monday can be calculated. When the average value [C] of the charging times is less than 2, the charging availability information about the specific charger Q can be determined as marginal, and when the average value [C] of the charging times is less than 2 and less than 4, the charging availability information can be determined to be good. Further, when the average value [C] of the charging times is 4 or more, the charging availability information may be determined as congested. In this way, the charging availability information according to the latent utilization rate may be considered more precise information about the charger Q by every time slot, when delivered to a vehicle moving around the charger Q or trying to use the charger Q. According to an embodiment, the predetermined criterion such as a threshold or a reference range to determine the charging availability information may vary.

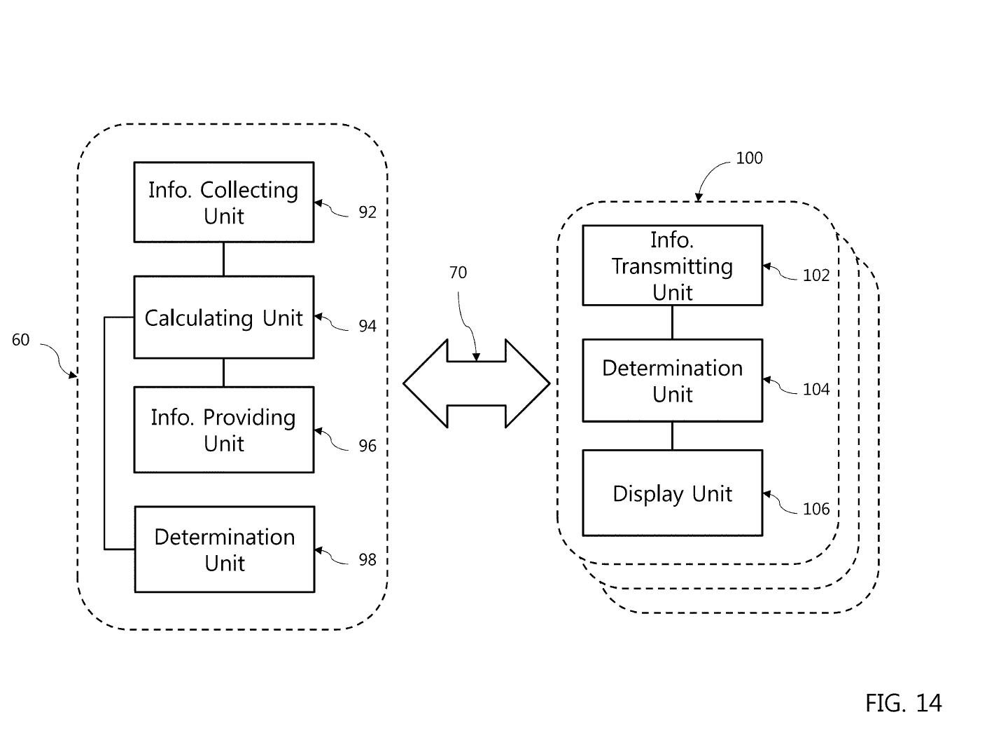

FIG. 14 shows an apparatus configured to provide the charging station information to a vehicle and an in-vehicle apparatus configured to show the charging station information.

As shown, a network server 60 may be communicated with or coupled to a plurality of vehicles 100 through a wireless network communication network 70.

The network server 60 configured to provide the charging station information to the vehicle can include an information collecting unit 92 configured to collect and store a battery charging state, a driving distance and a charging history delivered from each of the plurality of vehicles 100 through the wireless network communication network 70, a calculating unit 94 configured to calculate a latent utilization rate for each of a plurality of charging stations based on at least one of the battery charging state, the travelable distance and the charging history information, and an information providing unit 96 configured to deliver the latent utilization rate to the plurality of vehicles 100.

Further, the network server 60 may further include a determination unit 98 configured to determine the number of chargers included in the charging station and the failure of the chargers based on the charging history information. The information providing unit 96 may provide the number of the chargers and the failure of the chargers with the latent utilization rate to the plurality of vehicles 100.

By way of example but not limitation, the calculation unit 94 included in the network server 60 that provides the charging station information to the vehicle may be configured to classify a plurality of vehicles based on a predetermined area with reference to positions of the plurality of vehicles. The number of chargeable vehicles can be determined based on at least one of a battery charging state and a driving distance delivered from each of vehicles located or moving within the predetermined area. Also, the number of available chargers in at least one charging station within the predetermined area can be determined based on collected vehicle history information or provided information regarding charging station, which can be provided in advance. The calculation unit 94 can determine a latent utilization rate (unit: %) by dividing the number of chargeable vehicles to be charged by the number of available chargers and then multiplying divided value by 100.

In an embodiment, the calculation unit 94 included in the network server 60 configured to provide the charging station information to the vehicle can classify the charging history information collected from the plurality of vehicles on the basis of a predetermined area and a predetermined time. The calculation unit 94 can determine the number of charging times classified according to the predetermined area and the predetermined time, and the number of available chargers in charging stations located in the predetermined area. The calculation 94 can calculate the latent utilization rate based on the number of charging times and the number of available chargers. Here, the number of charging times may be calculated by dividing the total number of charging times by a day of the week in the past month, and obtained as average on charging times by the day of the week and the time (e.g., every hours). The latent utilization rate can be obtained by dividing the average of a day or a time by the number of available chargers, then multiplying divided value by 100.

The calculating unit 94 included in the network server 60 providing the charging station information to the vehicle can determine the number of vehicles, each moving or stopping within a predetermined distance from the charging station and having either a battery charging state lower than a predetermined level or a driving distance shorter than a threshold. The latent utilization rate can be determined based on the number of vehicles required to be charged and a predetermined criterion. By way of example but not limitation, the predetermined distance may be 0.5 to 1.0 times the threshold, or 0.5 to 1.0 times the maximum driving distance depending on the predetermined level. In addition, the predetermined criterion may correspond to the number of available chargers included in the charging station.

In an embodiment, the calculation unit 94 included in the network server 60 configured to provide the charging station information to the vehicle can divide the charging history information collected from each of a plurality of vehicles on the basis of a position of charging station and a predetermined time. It is possible to determine the number of charging times at a specific charging station or a specific charger according to a time (or hours), and to determine the latent utilization rate based on the number of charging times and a predetermined criterion. By way of example but not limitation, the number of charging times is calculated by dividing the total number of charging times by a day of the week in the past month based on the specific charging station, and calculating an average for each day or every hour(s) regarding the number of charging times. Then, the latent utilization rate can be obtained by dividing the average per day and hours by the number of available chargers, and multiplying divided value by 100.

In an embodiment, a device included in the vehicle 100, which is capable of displaying charging station information, may be communicated with or connected to the network server 60 that provides the charging station information to each vehicle 100 through a wireless network communication network 70. The device can be provided with an information transmitting unit 102 configured to transmit a battery charging state, a driving distance and charging history information via the wireless network communication network 70 to the network sever 60, a determination unit 104 configured to determine the charging availability information for each of a plurality of charging stations or chargers based on the latent utilization rate transmitted through the wireless network communication network 70 from the network sever 60, and a display unit 106 configured to display the charging availability information in a predetermined format.

Herein, the charging availability information based on the latent usage rate can be determined as one of plural classes such as congested, good and marginal, and shown through a display of a head unit or a multimedia device as a form of symbols or marks having at least one of different colors, shapes, and phrases, each matched with each class. By way of example but not limitation, when the latent utilization rate is less than 200%, the charge estimation information can be determined as marginal. If the latent utilization rate is 200% or more and less than 400%, the charge estimation information can be determined as good. If the latent utilization rate is 400% or more, the charging availability information can be determined as congested.

In an embodiment, when the latent utilization rate delivered from the network server 60 is determined based on an average of the number of charging times at a specific charging station or charger, the charging availability information can be determined according to a predetermined threshold or a criterion range. Further, the network sever 60 can determine the charging availability information based on the latent utilization rate and provide the charging availability information with a location of the specific charging station or charger to a user or a driver of the vehicle.

As above described, embodiments in the disclosure can provide more accurate charging station information to a user or a driver of an electric vehicle, thereby increasing or enhancing a mobility and/or range of the electric vehicle.

Further, in order to provide information related to a charging station to a vehicle, embodiments can utilize information for maintenance, management or driving, which is delivered from a plurality of other electric vehicles and gathered or collected by a network sever, as a source for determining charging station information. Since it is not required to receive information provided from an operator or a business entity operating the charging station or charger for determining the charging station information to be provided to an electric vehicle, it is likely that an organization or a business entity for providing maintenance, management or driving information to the electric vehicle can determine and provide the charging station information independently, i.e., without aid, cooperation, or support of the operator or the business entity operating the charging station.

The aforementioned embodiments are achieved by disclosure in a predetermined manner Each of the structural combination of structural elements and features of the elements or features can be considered selectively unless specified separately. Each of the structural elements or features may be carried out without being combined with other structural elements or features. Also, some structural elements and/or features may be combined with one another to constitute the embodiments of the disclosure. The order of operations described in the embodiments of the disclosure may be changed. Some structural elements or features of one embodiment may be included in another embodiment, or may be replaced with corresponding structural elements or features of another embodiment. Moreover, it will be apparent that some claims referring to specific claims may be combined with another claims referring to the other claims other than the specific claims to constitute the embodiment or add new claims by means of amendment after the application is filed.

Various embodiments may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet).

It will be apparent to those skilled in the art that various modifications and variations can be made in the present disclosure without departing from the spirit or scope of the disclosures. Thus, it is intended that the disclosure covers the modifications and variations of this disclosure provided they come within the scope of the appended claims and their equivalents.

What is claimed is:

1. A method for providing charging station information to a vehicle, comprising:
collecting a battery charging state, a driving distance and a charging history from a plurality of vehicles;
calculating a latent utilization rate regarding at least one charging station based on at least one of the battery charging state, the driving distance and the charging history; and
determining charging availability information regarding the at least one charging station based on the latent utilization rate to provide the charging availability information to at least one vehicle included in the plurality of vehicles.

2. The method according to claim 1, wherein the latent utilization information (unit: %) is obtained by:
either dividing the number of charging vehicles by the number of available chargers or dividing an average of charging times by the hour from the charging history by the number of available chargers; and
multiplying divided value by 100.

3. The method according to claim 2, wherein the charging availability information based on the latent utilization rate is classified into one of congested, good and marginal, and is displayed through at least one of different colors, shapes and phrases, and wherein each color, each shape or each phrase corresponds to one of congested, good and marginal.

4. The method according to claim 2, wherein:
when the latent utilization rate is less than 200%, the charging availability information is determined as marginal,
when the latent utilization rate is 200% or more and less than 400%, the charging availability information is determined as good, and
when the latent utilization information is equal to or greater than 400%, the charging availability information is determined as congested.

5. The method according to claim 1, wherein calculating the latent utilization rate comprises:
recognizing locations of the vehicles and classifying the plurality of vehicles based on whether each vehicle is located within a predetermined region;
determining the number of charging vehicles, each of which requires charging based on at least one of the battery charging state and the driving distance delivered from each vehicle located in the predetermined region;
determining the number of available chargers in the at least one charging station located in the predetermined region; and
calculating the latent utilization rate based on the number of the charging vehicles and the number of the available chargers.

6. The method according to claim 1, wherein calculating the latent utilization rate comprises:
classifying the charging history collected from the plurality of vehicles based on a predetermined region and a predetermined time;
determining the number of charging times in response to the predetermined region and the predetermined time;
determining the number of available chargers in the at least one charging station located in the predetermined region; and
calculating the latent utilization rate based on the number of charging times and the number of available chargers.

7. The method according to claim 1, wherein calculating the latent utilization rate comprises:
determining the number of target vehicles which are moving within a predetermined distance from location of the at least one charging station and whose battery charging state is less than a predetermined level or driving distance is less than or equal to a threshold value; and
calculating the latent utilization rate based on the number of target vehicles and the number of chargers included in the at least one charging station.

8. The method according to claim 8, wherein the predetermined distance is 0.5 to 1.0 times the threshold value or 0.5 to 1.0 times the maximum driving distance according to the predetermined level.

9. The method according to claim 1, wherein calculating the latent utilization rate comprises:
classifying the charging history collected from the plurality of vehicles based on location of the at least one charging station and a predetermined time;
determining the number of charging times according to the location of the at least one charging station and the predetermined time; and
calculating the latent utilization rate based on the number of charging times and the number of available chargers.

10. The method according to claim 1, further comprising:
analyzing the charging history to recognize the number of chargers included in the at least one charging station as well as whether each of the chargers is failed.

11. An apparatus for providing a charging station information to a vehicle, comprising:
an information collecting unit configured to collect and store a battery charging state, a driving distance and a charging history from a plurality of vehicles through a wireless network;
a calculation unit configured to calculate a latent utilization rate regarding at least one charging station based on at least one of the battery charging state, the driving distance and the charging history; and
an information providing unit configured to provide the latent utilization rate to at least one vehicle included in the plurality of vehicles.

12. The apparatus according to claim 11, further comprising:
a determination unit configured to analyze the charging history to determine the number of chargers included in the at least one charging station as well as whether each of the chargers is failed,
wherein the information providing unit provides the latent utilization rate as well as the number of chargers and whether each of the chargers is failed.

13. The apparatus according to claim 11, wherein the latent utilization information (unit: %) is obtained by:
either dividing the number of charging vehicles by the number of available chargers or dividing an average of charging times by the hour from the charging history by the number of available chargers; and
multiplying divided value by 100.

14. The apparatus according to claim 11, wherein the calculation unit is configured to:
recognize locations of the vehicles and classifying the plurality of vehicles based on whether each vehicle is located within a predetermined region;
determine the number of charging vehicles, each of which requires charging based on at least one of the battery charging state and the driving distance delivered from each vehicle located in the predetermined region;
determine the number of available chargers in the at least one charging station located in the predetermined region; and
calculate the latent utilization rate based on the number of the charging vehicles and the number of the available chargers.

15. The apparatus according to claim 11, wherein the calculating unit is configured to:
classify the charging history collected from the plurality of vehicles based on a predetermined region and a predetermined time;
determine the number of charging times in response to the predetermined region and the predetermined time;
determine the number of available chargers in the at least one charging station located in the predetermined region; and
calculate the latent utilization rate based on the number of charging times and the number of available chargers.

16. The apparatus according to claim 11, wherein the calculating unit is configured to:
determine the number of target vehicles which are moving within a predetermined distance from location of the at least one charging station and whose battery charging state is less than a predetermined level or driving distance is less than or equal to a threshold value; and
calculate the latent utilization rate based on the number of target vehicles and the number of chargers included in the at least one charging station.

17. The apparatus according to claim 11, wherein the calculating unit is configured to:
classify the charging history collected from the plurality of vehicles based on location of the at least one charging station and a predetermined time;
determine the number of charging times according to the location of the at least one charging station and the predetermined time; and
calculate the latent utilization rate based on the number of charging times and the number of available chargers.

18. An in-vehicle apparatus for showing charging station information, comprising:
an information transmission unit configured to transmit a battery charging state, a driving distance and a charging history through the wireless network;
a determination unit configured to determine charging availability information regarding the at least one charging station based on at least one of a latent utilization rate and the number of charging times delivered through the wireless network; and
a display unit configured to display the charging availability information in a predetermined form.

19. The in-vehicle apparatus according to claim 18, wherein the charging availability information based on the latent utilization rate is classified into one of congested, good and marginal, and is displayed through at least one of different colors, shapes and phrases, and wherein each color, each shape or each phrase corresponds to one of the congested, the good and the marginal.
